(19) United States
(12) Patent Application Publication
(10) Pub. No.: US 2017/0004105 A1
(43) Pub. Date: Jan. 5, 2017

(54) ADD-ON DEVICE AND SERVER USING THE SAME

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventors: KANG WU, Shenzhen (CN); BO TIAN, Shenzhen (CN)

(21) Appl. No.: 14/824,853

(22) Filed: Aug. 12, 2015

(30) Foreign Application Priority Data
Jul. 2, 2015 (CN) 201510380389.1

(51) Int. Cl. G06F 13/40; G06F 13/42

(52) U.S. Cl. CPC G06F 13/4068; G06F 13/4221

(57) ABSTRACT

An add-on device includes an interface, an identification module, an enable module, and a function module. The identification module is used to output an identification signal. The enable module is used to receive an enable signal. The function module is used to process signals. The enable module activates the function module to operate when the enable module receives the enable signal.

### FIELD

The subject matter herein generally relates to an add-on device and a server using the same.

### BACKGROUND

Servers need to identify add-on devices first before enabling the add-on devices.

### BRIEF DESCRIPTION OF THE DRAWINGS

Implementations of the present technology will now be described, by way of example only, with reference to the attached figures.

FIG. 1 is a block diagram of an embodiment of an add-on device.

FIG. 2 is a block diagram of an embodiment of a server using add-on devices.

FIG. 3 is a circuit diagram of an embodiment of an identification module of the add-on device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently coupled or releasably coupled. The term “comprising,” when utilized, means “including, but not necessarily limited to”; it specifically indicates open-ended inclusion or membership in the so-described combination, group, series and the like.

The disclosure will now be described in relation to an electronic device with a power switch system.

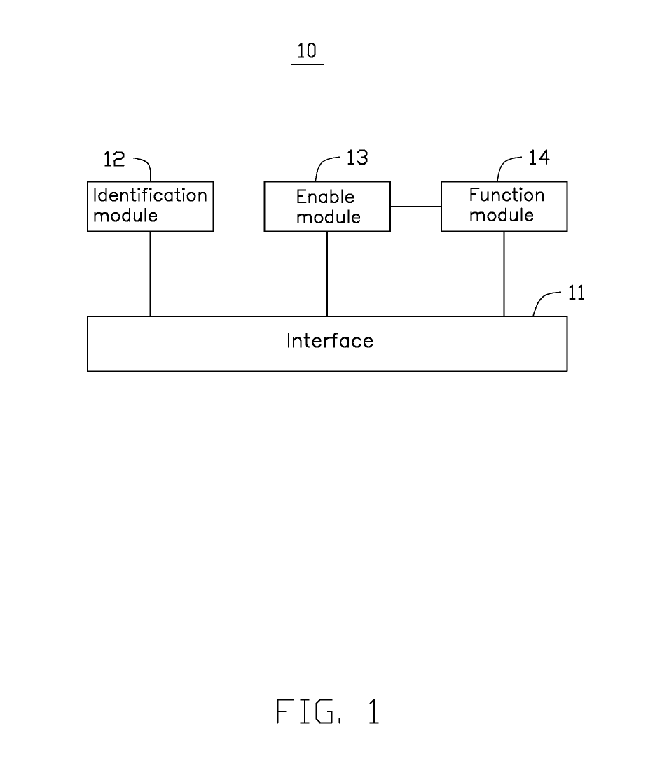

FIG. 1 shows an embodiment of an add-on device 10. The add-on device 10 can comprise an interface 11, an identification module 12, an enable module 13, and a function module 14. The identification module 12 is configured to output an identification signal through the interface 11. The enable module 13 is configured to receive an enable signal through the interface 11. The enable module 13 activates the function module 14 to process signals when the enable module 13 receives the enable signal.

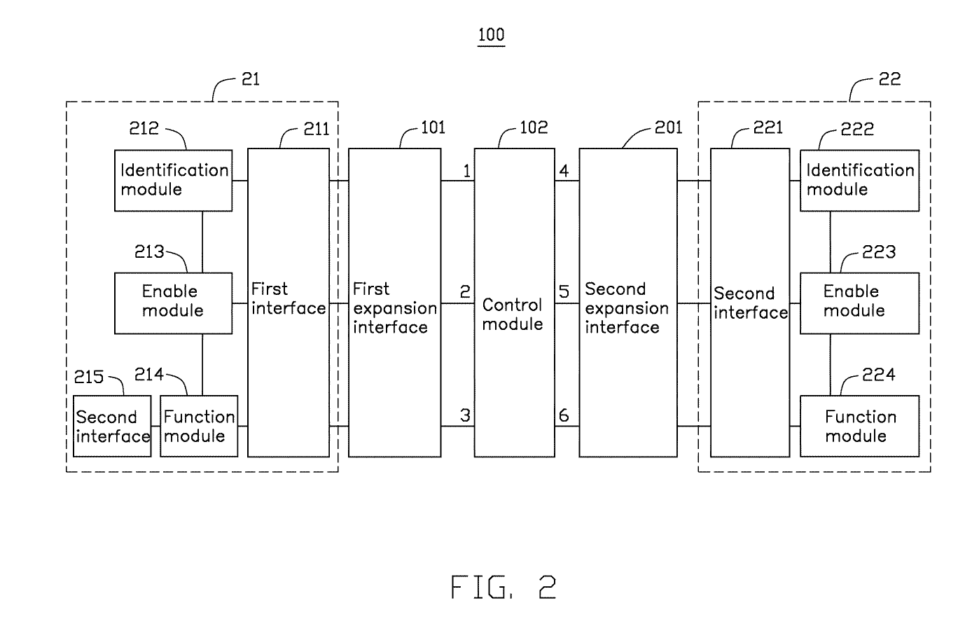

FIG. 2 shows an embodiment of a server 100 using add-on devices. The server 100 can comprise a first add-on device 21, a second add-on device 22, a first expansion interface 101, a second expansion interface 201, and a control module 102.

The first add-on device 21 can comprise a first interface 211, an identification module 212, an enable module 213, a function module 214, and a third interface 215.

The second add-on device 22 can comprise a second interface 221, an identification module 222, an enable module 223, and a function module 224.

The control module 102 can comprise a first pin 1, a second pin 2, a third pin 3, a fourth pin 4, a fifth pin 5, and a sixth pin 6. The first pin 1 is coupled to the identification module 212 through the first expansion interface 101 and the first interface 211 in that order. The second pin 2 is coupled to the enable module 213 through the first expansion interface 101 and the first interface 211 in that order. The third pin 3 is coupled to the function module 214 through the first expansion interface 101 and the first interface 211 in that order. The fourth pin 4 is coupled to the identification module 222 through the second expansion interface 201 and the second interface 221 in that order. The fifth pin 5 is coupled to the enable module 223 through the second expansion interface 201 and the second interface 221 in that order. The sixth pin 6 is coupled to the function module 224 through the second expansion interface 201 and the second interface 221 in that order.

When the first add-on device 21 is coupled to the first expansion interface 101, the identification module 212 outputs a first identification signal. The control module 102 receives the first identification signal through the first pin 1. The control module 102 outputs a first enable signal through the second pin 2. The enable module 213 receives the first enable signal and activates the function module 214 to operate. The function module 214 couples to the third interface 215 and the third pin 3 of the control module 102 to transmit signals.

When the second add-on device 22 is coupled to the second expansion interface 201, the identification module 222 outputs a second identification signal. The control module 102 receives the second identification signal through the fourth pin 4. The control module outputs a second enable signal through the fifth pin 5. The enable module 223 receives the second enable signal and activates the function module 224 to operate.

In the embodiment, the control module 102 is a platform control hub. The first add-on device 21 and the second add-on device 22 are network cards. The function module 214 is configured to transmit signals between the server 100 and the internet.

In other embodiments, the first and second expansion interfaces 101/201 can be coupled to different kinds of add-on devices. When the second add-on device 22 is coupled to the first expansion interface 101, the identification module 222 outputs the second identification signal. The control module 102 receives the second identification signal through the first pin 1 and outputs the second enable signal through the second pin 2. The enable module 213 receives the second enable signal and activates the function module 224 to operate.

In the embodiment, both of the identification modules 212/222 comprise a signal generator. The first identification has a first frequency. The second identification has a second frequency.

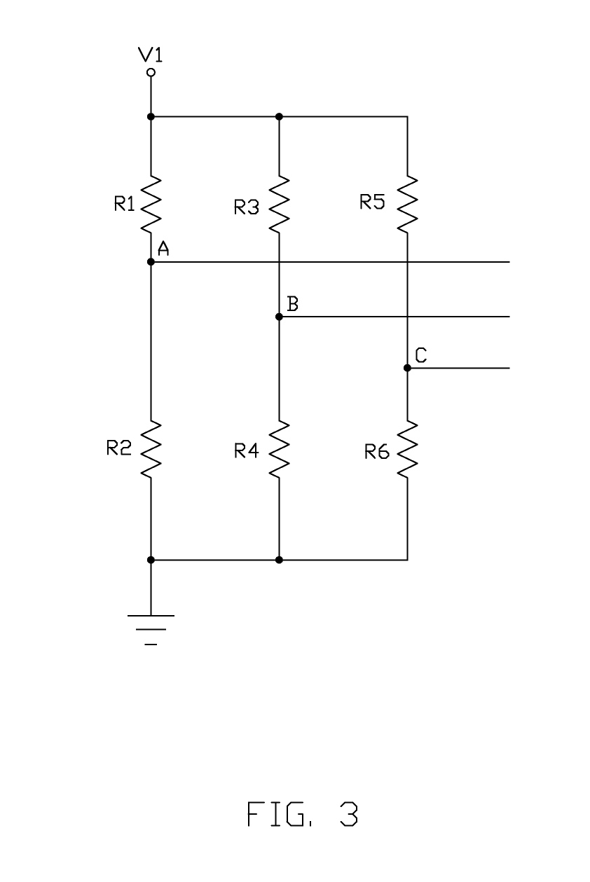

FIG. 3 shows another embodiment of the identification module 12 of the add-on device 10. The identification module 12 can comprise resistor R1-R6 and a power terminal V1. The power terminal V1 is grounded through the resistor R1 and the resistor R2 in that order. The power terminal V1 is grounded through the resistor R3 and the resistor R4 in that order. The power terminal V1 is also grounded through the resistor R5 and the resistor R6 in that order. A voltage of a node A between the resistor R1 and the resistor R2 depends on resistances of the resistor R1 and the resistor R2. A voltage of a node B between the resistor R3 and the resistor R4 depends on resistances of the resistor R3 and the resistor R4. A voltage of a node C between the resistor R5 and the resistor R6 depends on resistances of the resistor R5 and the resistor R6. The identification module 12 can be identified by adjusting electrical levels of the nodes A, B, and C.

While the disclosure has been described by way of example and in terms of the embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. An add-on device comprising:
an identification module configured to output an identification signal;
an enable module configured to receive an enable signal; and
a function module to process signals, wherein the enable module activates the function module in event the enable module receives the enable signal.

2. The add-on device as claim 1, wherein the identification module further comprises a signal generator.

3. The add-on device as claim 1, wherein the identification module comprises first through sixth resistors and a power terminal, wherein the power terminal is grounded through the first resistor and the second resistor in that order, the power terminal is grounded through the third resistor and the fourth resistor in that order, the power terminal is grounded through the fifth resistor and the sixth resistor in that order.

4. A server comprising:
a first add-on device comprising a first interface, a first identification module, a first enable module, and a first function module;
a first expansion interface configured to couple the first add-on device; and
a control module comprising first through third pins, wherein the first pin is configured to couple the first identification module through the first expansion interface and the first interface in that order, the second pin is configured to couple the first enable module through the first expansion interface and the first interface in that order, the third pin is configured to couple the first function module through the first expansion interface and the first interface in that order, when the first add-on device is coupled to the server, the first identification module outputs a first identification signal, the control module receives the first identification signal and outputs a first enable signal to the first enable module, the first enable module receives the first enable signal and activates the first function module to operate.

5. The server as claim 4, further comprising a second add-on device and a second expansion interface, wherein the second add-on device comprises a second interface, a second identification module, a second enable module, and a second function module, the second add-on device is coupled to the second expansion interface, the second identification is coupled to a fourth pin of the control module through the second expansion interface and the second interface, the second enable module is coupled to a fifth pin of the control module through the second expansion interface and the second interface, the second function module is coupled to a sixth pin of the control module through the second expansion interface and the second interface.

6. The server as claim 5, wherein the first add-on device and the second add-on device are network cards.

7. The server as claim 5, wherein when the second add-on device is coupled to the server, the second identification module outputs a second identification signal, the control module receives the second identification signal and outputs a second enable signal, the second enable module receives the second enable signal and activates the second function module to operate.

8. The server as claim 4, wherein the first identification comprises a signal generator.

9. The server as claim 8, wherein the first identification comprises a signal generator, the second identification comprises a signal generator.

10. The server as claim 4, wherein the control module is a platform controller hub.
